(19) United States
(12) Patent Application Publication
(10) Pub. No.: US 2007/0114272 A1
(43) Pub. Date: May 24, 2007

(54) Dispenser for monetary items

(75) Inventors: Frank Bleck, Paderborn (DE); Gunter Holland-Letz, Paderborn (DE); Ulrich Neumann, Lippstadt (DE)

Correspondence Address: HARNESS, DICKEY & PIERCE, P.L.C., P.O. BOX 828, BLOOMFIELD HILLS, MI, 48303, US

(73) Assignee: Wincor Nixdorf International GmbH, Paderborn (DE)

(21) Appl. No.: 10/582,533

(22) PCT Filed: Nov. 16, 2004
(86) PCT No.: PCT/EP04/12994

§ 371 Date: Jun. 9, 2006

(30) Foreign Application Priority Data
Dec. 12, 2003 (DE) 103 58 761.6
Jan. 9, 2004 (DE) 10 2004 001 477.9

(51) Int. Cl. G07F 19/00

(52) U.S. Cl. 235/379

(57) ABSTRACT

The invention relates to a dispenser for monetary items, in which the deposit and withdrawal module is mounted so that it can pivot in relation to the processing module, between a deposit and a withdrawal position and a processing position.

The invention is directed to a dispenser for monetary items, by which currency, in particular bank notes or also checks, can be deposited or withdrawn.

A dispenser for monetary items, in particular a withdrawal and deposit automated teller, includes a plurality of bank note cassettes for reception of the to be withdrawn bank notes, as well as storage devices to store the deposited money. Other money withdrawal and deposit automated tellers are also known, with which the cassettes serve for the money withdrawal and money deposit. The bank note cassettes are each positioned in a vertical position and a horizontal row behind one another. Furthermore, outlet and separating devices that are allotted to the bank note cassettes, a stack device to form a bundle of to be withdrawn bank notes, a single sheet transport device to transport individual bank notes from the outlet and separating devices to the stack device, and a collective transport device for the transport of a bank note bundle from the stack device to a deposit and withdrawal compartment of the automated teller are provided. For the money deposit are furthermore provided a separating device, as well as a money proof module, which checks the authenticity of the deposited money, and apparatuses for the transportation of the money to the storage devices.

In order to achieve structurally simple, accessible units, different processing apparatuses are combined into modules. Accordingly, a deposit and withdrawal module is provided, which, besides the deposit and withdrawal compartment, also includes collection and separating apparatuses. This deposit and withdrawal module is coupled with the subsequent processing and transport units. In particular, with a customary forming of the processing module, the deposit and withdrawal module is located in an upper area of a substantially cube-formed processing unit. Because the processing units are located above the money cassettes, this leads to a very high build height of the automated teller and an ergonomically inappropriate form of the control panel on the customer side of the automated teller, or only a limited number of cassettes can be inserted if a lower build height is to be achieved.

It is the underlying object of the present invention, to so form an automated teller of the above-named kind, with as simple means as possible, such to achieve a low build height of the automated teller, and therewith to also provide an ergonomically appropriate arrangement of the control panel.

This objective is achieved in that a deposit and withdrawal module is pivotably mounted relative to the processing module, wherein it is pivotable between a deposit and a withdrawal position and a processing.

Further features and advantages of the invention are provided from the following description, which in connection with the attached figures details the invention on the basis of an exemplary embodiment. It is illustrated in:

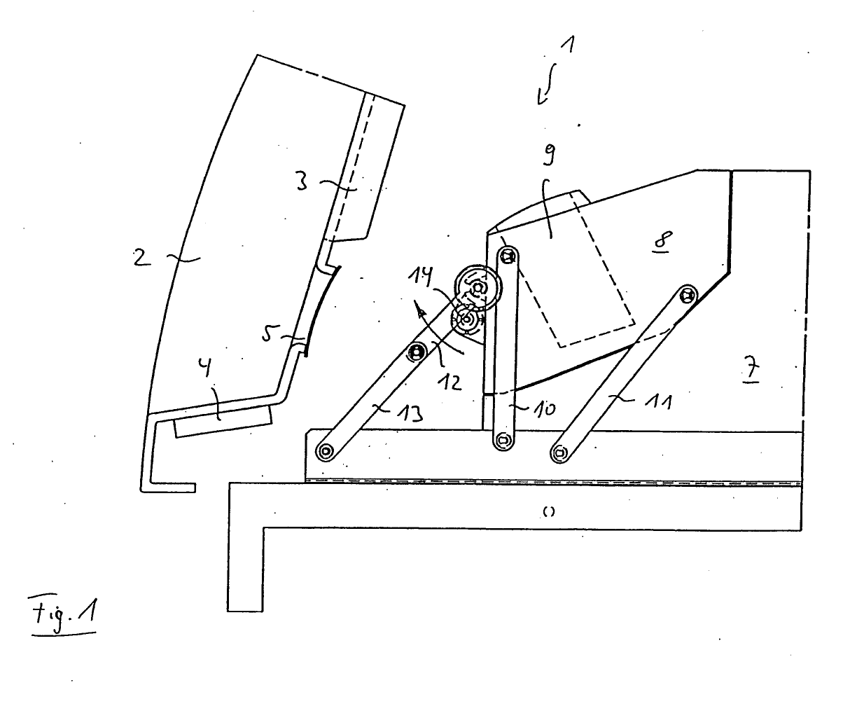

FIG. 1 a schematic side view of an upper area of an automated teller with a deposit and withdrawal module in accordance with the invention, in a processing position;

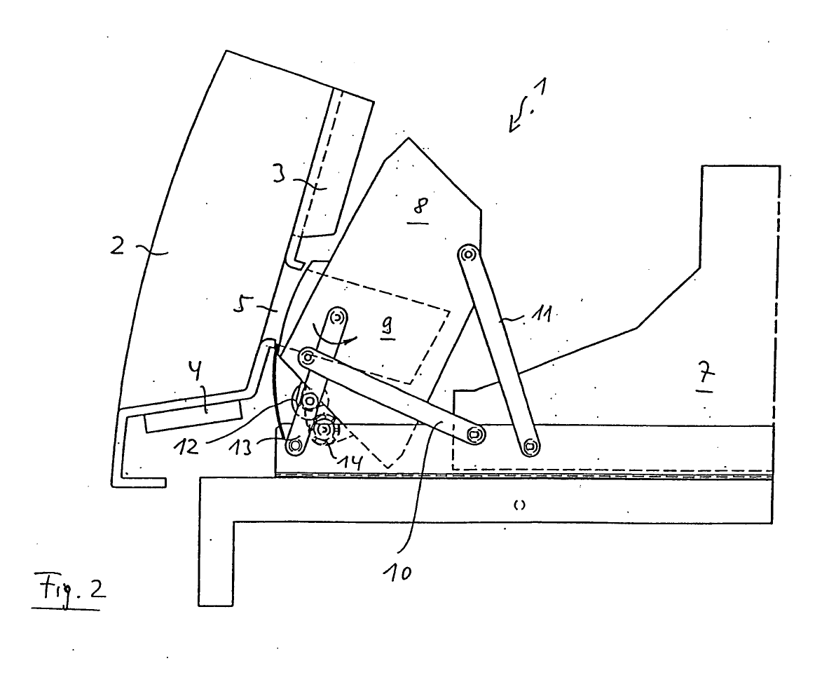

FIG. 2 a schematic side view of an upper area of an automated teller with a deposit and withdrawal module in accordance with the invention, in a deposit or withdrawal position.

FIG. 1 schematically shows an automated teller generally referenced with 1 with a covering 2, which includes a display 3, a control panel 4 and a recess 5 for the reception of a deposit and withdrawal compartment. Behind the covering 2 are located the several processing and transport modules of the automated teller, which are not illustrated here in detail and are generally indicated as processing module 7. Connected to this processing module 7 is a withdrawal and deposit module 8, which includes a collector unit for the collection of individual the notes arriving from the transport apparatuses to a bundle, and a separating unit that separates a deposited note bundle to individual notes, both of which are not illustrated here in detail. Further, a deposit and withdrawal compartment 9 is provided, in which the withdrawn money is offered to the customer or in which the customer can deposit money. Besides the processing and collection mechanics, the module 8 contains still several activatable pressure elements and short transports legs, as well as monitoring sensors, so that the module 8 altogether includes a high weight.

In the deposit and withdrawal position, the deposit and withdrawal compartment 9 comes into engagement with the recess 5 of the covering 2 and is preferably located in an only slightly inclined position relative to a horizontal, so that an ergonomic operation of the deposit and withdrawal of the money is quite possible. If the deposit and withdrawal module 8 is oppositely pivoted, it comes into engagement with the processing module 7 and the deposit and withdrawal compartment 9 is inclined by more than 45 degrees relative to the horizontal.

A pivot mechanism is provided for pivoting of the deposit and withdrawal module 8, and which pivots and precisely positions the module 8 on the stop areas. Besides that, the module 8 is still lowered into the deposit and withdrawal position. For this, a four hinge design is provided, which pivots the module 8 along a coupling curve. The four hinge design is formed of two hinge bars 10, 11, which are provided on both sides of the module 8 and couples it with the processing module 7. The pivot drive of the module 8 is preferably achieved through a crank drive with a crank 12, which is hinged to a stationary guide 13. The guide 13 is preferably likewise coupled with the processing module 7. The crank is pivoted about 180 degrees between the processing position and the deposit and withdrawal position, and finds itself in both end positions in a straight position. From the straight positions forward, the movement occurs with a sinusoidal shaped path-time characteristic, wherein the acceleration and the braking include no large force peaks. The stop positions of the module 8 are determined by the lengths of the crank 12 and the guide 14. The crank 12 is driven by a drive motor 14, which is preferably provided as a direct-current motor with planetary transmission.

Before reaching the end position, the motor 14 is shorted, so that the module 8 is braked and the end position achieved.

Besides the construction of the guide of the pivot movement as a four hinge design, it is also possible within the framework of the invention to provide a cam guide.

Through the pivotable support of the deposit and withdrawal module relative to the processing module between a deposit and a withdrawal position, a low build height of the automated teller is provided, and therewith an ergonomically appropriate form of the control panel, wherein a large number of money cassettes can concurrently be accommodated in the automated teller.

1. An automated teller for the deposit and/or withdrawal of monetary items with a closable housing, that has a recess for the deposit and withdrawal of monetary items, and with a deposit and withdrawal module for the deposit and withdrawal of monetary items, and with a processing module wherein the deposit and withdrawal module is pivotably supported relative to the processing module, wherein it is pivotable between a deposit and withdrawal position and a processing position.

2. An automated teller in accordance with claim 1, wherein the deposit module is pivotably guided by means of a four hinge design comprising two hinge bars which are respectively hinged to the deposit module and the processing module.

3. An automated teller in accordance with claim 2, wherein a crank drive is provided for the pivoting of the deposit and withdrawal modules.

4. An automated teller in accordance with claim 1, wherein the automated teller includes a low build height as well as an ergonomically appropriate form of the control panel on the customer side through the pivotably movable support of the and withdrawal position, wherein a large number of cassettes can be concurrently accommodated in the automated teller.

5. An automated teller in accordance with claim 2, wherein the automated teller includes a low build height as well as an ergonomically appropriate form of the control panel on the customer side through the pivotably movable support of the deposit and withdrawal module relative to the processing module between a deposit and withdrawal position, wherein a large number of cassettes can be concurrently accommodated in the automated teller.

6. An automated teller in accordance with claim 3, wherein the automated teller includes a low build height as well as an ergonomically appropriate form of the control panel on the customer side through the pivotably movable support of the deposit and withdrawal module relative to the processing module between a deposit and withdrawal position, wherein a large number of cassettes can be concurrently accommodated in the automated teller.
